(19) United States
(12) Patent Application Publication
(10) Pub. No.: US 2022/0259105 A1
(43) Pub. Date: Aug. 18, 2022

(54) MIXTURES FOR COATING METAL SUBSTRATE

(71) Applicant: PRINCE MINERALS LIMITED, Staffordshire (GB)

(72) Inventors: Michael Prescott, Staffordshire (GB); Vincent Guasp, Staffordshire (GB); Philip Frampton, Paris (FR)

(21) Appl. No.: 17/625,889

(22) PCT Filed: Jul. 9, 2020
(86) PCT No.: PCT/GB2020/051651

§ 371 Date: Jan. 10, 2022

(30) Foreign Application Priority Data
Jul. 10, 2019 (GB) 1909872.2

(51) Int. Cl. C04B 28/26; C04B 14/22; C23F 15/00

(52) U.S. Cl. CPC C04B 28/26; C04B 2111/00525; C23F 15/005; C04B 14/22

(57) ABSTRACT

A mixture for coating a metal substrate to prevent or limit scale formation. The mixture comprises 20 to 90% by weight of at least one of: an oxide ceramic material, an aluminosilicate mineral or glass frit. The mixture further comprises 1 to 20% by weight of clay and 3 to 70% by weight of an alkali metal silicate.

### TECHNOLOGICAL FIELD

Examples of the disclosure relate to mixtures for coating metal substrates to prevent or limit scale formation, and a method of preventing or limiting scale formation on a metal substrate.

### BACKGROUND

Forming processes, such as hot rolling, convert solidified metal substrates such as slabs, billets or ingots into products useful for the fabricating and construction industries. Such forming processes are carried out hot, at about 1200° C. or above. This requires the use of reheating furnaces to heat the metal substrates to the required temperature. In some instances, the metal substrates may be at ambient temperature prior to reheating. Alternatively, the metal substrates may already be hot prior to reheating, for instance at about 800° C., in continuous casting operations.

During the process of reheating, significant levels of scale form on the surface of some metal substrates, for instance on metal substrates comprising iron such as steel substrates, due to oxidation of iron in the metal to iron oxides. Scale must be substantially removed before and during such forming processes, for instance, by high pressure water jets to preserve the quality of the metal.

Scale formation and its subsequent removal results in a loss of metal, for instance steel, which is a significant problem in the metal industry. This is particularly the case for the reheating of metal substrates which have a large surface area.

There is a desire therefore to reduce or prevent the formation of scale during reheating of metal substrates. All proportions referred to in this specification are indicated as % by weight of the total composition, unless specified otherwise.

### BRIEF SUMMARY

According to various, but not necessarily all, examples of the disclosure there is provided a mixture for coating a metal substrate to prevent or limit scale formation, wherein the mixture comprises:

20 to 90% by weight of at least one of: an oxide ceramic material, an aluminosilicate mineral or glass frit; the mixture further comprising:

1 to 20% by weight of clay; and

3 to 70% by weight of an alkali metal silicate.

The oxide ceramic material may comprise alumina or zirconium silicate. The aluminosilicate mineral may comprise mica.

The alkali metal silicate may comprise any of: sodium silicate, potassium silicate or lithium silicate. The clay may comprise china clay or ball clay

The mixture may comprise 30 to 85% by weight of the at least one of: an oxide ceramic material, an aluminosilicate mineral, or glass frit, and may comprise 35 to 80% by weight of the at least one of: an oxide ceramic material, an aluminosilicate mineral, or glass frit.

The mixture may comprise 3 to 18% by weight of clay, and may comprise 5 to 17% by weight of clay.

The mixture may comprise 5 to 60% by weight of alkali metal silicate, and may comprise 6 to 55% by weight of alkali metal silicate.

The mixture may comprise a rheology modifier. The rheology modifier may comprise a hydrocolloid, or may comprise a gum. The gum may comprise xanthan gum. The mixture may comprise 0.1% to 1.0% by weight of rheology modifier, and may comprise 0.1 to 0.8% by weight of rheology modifier, and may comprise 0.2 to 0.5% by weight of rheology modifier.

The mixture may comprise water.

The glass frit may comprise a plurality of different glass frits, wherein each respective glass frit has a different chemical composition. Each respective glass frit may have a different softening point. The glass frit may comprise 2 to 5 different glass frits. The glass frit may comprise silicate glass frit.

According to various, but not necessarily all, examples of the disclosure there is provided a mixture for coating a metal substrate to prevent or limit scale formation, wherein the mixture comprises:

an oxide ceramic material;

clay; and

an alkali metal silicate.

According to various, but not necessarily all, examples of the disclosure there is provided a mixture for coating a metal substrate to prevent or limit scale formation, wherein the mixture comprises:

an aluminosilicate mineral;

clay; and

an alkali metal silicate.

According to various, but not necessarily all, examples of the disclosure there is provided a mixture for coating a metal substrate to prevent or limit scale formation, wherein the mixture comprises:

Glass frit;

clay; and

an alkali metal silicate.

According to various, but not necessarily all, examples of the disclosure there is provided a mixture for coating a metal substrate to prevent or limit scale formation, wherein the mixture comprises:

an oxide ceramic material;

an aluminosilicate mineral;

clay; and

an alkali metal silicate.

According to various, but not necessarily all, examples of the disclosure there is provided a mixture for coating a metal substrate to prevent or limit scale formation, wherein the mixture comprises:

an oxide ceramic material;

glass frit;

clay; and

an alkali metal silicate.

According to various, but not necessarily all, examples of the disclosure there is provided a mixture for coating a metal substrate to prevent or limit scale formation, wherein the mixture comprises:

an aluminosilicate mineral;

glass frit;

clay; and

an alkali metal silicate.

According to various, but not necessarily all, examples of the disclosure there is provided a mixture for coating a metal substrate to prevent or limit scale formation, wherein the mixture comprises:

an oxide ceramic material;

an aluminosilicate mineral;

glass frit;

clay; and

an alkali metal silicate.

According to various, but not necessarily all, examples of the disclosure there is provided a slurry for coating a metal substrate to prevent or limit scale formation, wherein the slurry comprises a mixture suspended in water, the mixture comprising:

20 to 90% by weight of at least one of: an oxide ceramic material, an aluminosilicate mineral or glass frit; the mixture further comprising:

1 to 20% by weight of clay; and

3 to 70% by weight of an alkali metal silicate.

The slurry may have a density relative to water of 1.2 to 2.2, and may have a density relative to water of 1.5 to 2.

According to various, but not necessarily all, examples of the disclosure there is provided a barrier to prevent or limit scale formation on a metal substrate, wherein the barrier is the reaction product of a mixture comprising:

20 to 90% by weight of at least one of: an oxide ceramic material, an aluminosilicate mineral or glass frit; the mixture further comprising:

1 to 20% by weight of clay; and

3 to 70% by weight of an alkali metal silicate.

According to various, but not necessarily all, examples of the disclosure there is provided a method of preventing or limiting scale formation on a metal substrate, wherein the method comprises:

coating the metal substrate with a mixture;

wherein the mixture comprises: 20 to 90% by weight of at least one of: an oxide ceramic material, an aluminosilicate mineral or glass frit; the mixture further comprising: 1 to 20% by weight of clay; and 3 to 70% by weight of an alkali metal silicate.

The method may comprise coating the metal substrate with the mixture to provide a layer with an average thickness of 100 μm to 400 μm, or with an average thickness of 200 μm to 400 μm, or with an average thickness of 250 μm to 300 μm.

The method may comprise coating the metal substrate with the mixture in a manual or automated process. The method may comprise spraying a slurry formed from the mixture onto the metal substrate.

Alternatively, the method may comprise electrostatically spraying the mixture onto the metal substrate. In such cases, mixtures according to examples of the disclosure may comprise about 0.5% by weight of silicone oil.

The method may comprise coating a metal substrate with the mixture when the temperature of the metal substrate is anywhere between ambient temperature and about 1300° C., and preferably when the temperature of the metal substrate is anywhere between ambient temperature and about 800° C. Ambient temperature may be between 0° C. and 50° C., for example. The mixture may be at ambient temperature.

In some examples, the coating applied to the metal substrate may begin to form a barrier to limit or prevent scale formation immediately following application of the mixture irrespective of the temperature of the metal substrate. In other examples, the coating applied to the metal substrate may begin to form a barrier to limit or prevent scale formation at an elevated temperature, for example, in excess of 500° C., or perhaps 800° C., or 900° C. depending on the composition of the mixture.

According to various, but not necessarily all, examples of the disclosure there may be provided examples as claimed in the appended claims.

### BRIEF DESCRIPTION

For a better understanding of various examples that are useful for understanding the detailed description, reference will now be made by way of example only.

### DETAILED DESCRIPTION

Examples of the disclosure provide a mixture for coating a metal substrate to prevent or limit scale formation. The mixture comprises 20 to 90% by weight of at least one of: an oxide ceramic material, an aluminosilicate mineral or glass frit.

Accordingly, example mixtures comprise an oxide ceramic material and/or an aluminosilicate mineral and/or glass frit.

Accordingly, example mixtures may comprise any of:

an oxide ceramic material; or

an aluminosilicate mineral; or

glass frit; or

an oxide ceramic material and an aluminosilicate mineral; or

an oxide ceramic material and glass frit; or

aluminosilicate mineral and glass frit; or

an oxide ceramic material and an aluminosilicate mineral and glass frit.

The mixture further comprises 1 to 20% by weight of clay, and 3 to 70% by weight of an alkali metal silicate.

In the illustrated examples, the metal substrate is steel. In other examples, the substrate may be a different metal, for instance a substrate comprising nickel or titanium.

Table 1 below provides examples of the disclosure.

TABLE 1

| | Example of | 1 | 2 | 3 | 4 | 5 | 6 | 7 | 8 |
|---|---|---|---|---|---|---|---|---|---|
| Component | component | wt/% | wt/% | wt/% | wt/% | wt/% | wt/% | wt/% | wt/% |
| Oxide ceramic | Alumina | 45.6 | 33.2 | 0 | 57.0 | 0 | 45.6 | 0 | 33.2 |
| material | | | | | | | | | |
| Aluminosilicate | Mica | 11.4 | 8.9 | 0 | 0 | 57.0 | 0 | 33.2 | 8.9 |
| mineral | | | | | | | | | |
| Glass frit | Silicate glass | 0 | 0 | 75.5 | 0 | 0 | 11.4 | 8.9 | 7.5 |
| | frit | | | | | | | | |
| Alkali metal | Sodium | 32.8 | 50.2 | 0 | 32.8 | 32.8 | 32.8 | 50.2 | 42.7 |
| silicate | silicate | | | | | | | | |
| | Potassium | 0 | 0 | 7.9 | 0 | 0 | 0 | 0 | 0 |
| | silicate | | | | | | | | |
| Clay | China clay | 10.0 | 7.7 | 0 | 10.0 | 10 | 10 | 7.7 | 7.7 |
| | Ball clay | 0 | 0 | 15.9 | 0 | 0 | 0 | 0 | 0 |
| Rheology | Hydrocolloid | 0.28 | 0 | 0 | 0.28 | 0.28 | 0.28 | 0 | 0 |
| modifier | preparation | | | | | | | | |
| | Gum | 0 | 0 | 0.79 | 0 | 0 | 0 | 0 | 0 |

As detailed in table 1, in some examples (for instance examples 1 & 2) the mixture comprises an oxide ceramic material and an aluminosilicate mineral. In such examples, the oxide ceramic material may comprise alumina or zirconium silicate.

In some examples, wherein the mixture comprises an oxide ceramic material and an aluminosilicate mineral, the mixture comprises 20 to 60% by weight of the oxide ceramic material. Preferably, the mixture comprises 25 to 55% by weight of the oxide ceramic material. Most preferably, the mixture comprises 30 to 50% by weight of the oxide ceramic material.

In some examples, wherein the mixture comprises an oxide ceramic material and an aluminosilicate mineral, the mixture comprises 3 to 20% by weight of aluminosilicate mineral. Preferably, the mixture comprises 5 to 15% by weight of aluminosilicate mineral. Most preferably, the mixture comprises 6 to 13% by weight of aluminosilicate mineral.

As detailed in table 1, in some examples (for instance, example 3) the mixture comprises glass frit.

In some examples, wherein the mixture comprises glass frit (for example instead of an oxide ceramic material and an aluminosilicate mineral), the mixture comprises 40 to 90% by weight glass frit. Preferably, the mixture comprises 60 to 90% by weight glass frit. Most preferably, the mixture comprises 65 to 85% by weight glass frit.

In some examples, an oxide ceramic material, such as alumina or zirconium silicate, and an aluminosilicate mineral is not required because the selected glass frit inherently has a glassy structure, and comprises aluminosilicate. A separate refractory element is not therefore required in some examples. However, in other examples in addition to glass frit the mixture may also comprise an oxide ceramic material and/or an aluminosilicate mineral.

In some examples, the glass frit comprises a plurality of different glass frits, wherein each respective glass frit has a different chemical composition. The glass frit may comprise 2 to 5 different glass frits. The glass frits are ground, for example by wet or dry ball milling, to an average diameter of less than 75 μm.

In some examples, the coating applied to the metal substrate may begin to form a barrier to limit or prevent scale formation immediately following application of the mixture irrespective of the temperature of the metal substrate. In other examples, the coating applied to the metal substrate may begin to form a barrier to limit or prevent scale formation at an elevated temperature, for example, in excess of 500° C., or perhaps 800° C., or 900° C. depending on the composition of the mixture.

In examples of the disclosure, the crystallographic and amorphous phases of the coating may change during the heating process, forming a barrier to prevent or limit scale formation. There may also be a degree of fusion between components of the mixture.

In examples comprising an oxide ceramic material and/or an aluminosilicate mineral, these components may act as a refractory element. The barrier formed from the coating may be an inhomogeneous material in view of the random dispersion of these refractory elements in the alkali metal silicate as it softens.

In examples comprising a plurality of different respective glass frits, each of which has a different softening point, during formation of the barrier, respective glass frits start to soften at their respective softening points, and therefore softening of the glass frit is over an extended period. During this process, glass frit which has not yet softened, or has only partly softened may dissolve to a degree in glass frit which has already softened, and there may be a degree of fusion between components of the mixture.

### Clay and an Alkali Metal Silicate

In combination, clay and alkali metal silicate provide a mineral based binder system which fuses the coating onto the surface of the metal substrate, and particularly when the metal substrate to which the mixture is being applied is already at an elevated temperature, e.g. above ambient temperature, for example above about 100° C. Without being bound by theory, at elevated temperatures clay and alkali metal silicate may form a geopolymer in a pozzolanic reaction. The alkali metal silicate may be, for example, sodium, potassium or lithium silicates. Sodium and potassium silicates are water soluble, and are therefore preferable in some examples of the disclosure.

In examples of the disclosure, the mixture comprises 1 to 20% by weight of clay. Preferably, the mixture comprises 3 to 18% by weight of clay. Most preferably, the mixture comprises 5 to 17% by weight of the clay.

In examples of the disclosure, the mixture comprises 3 to 70% by weight of alkali metal silicate. Preferably, the mixture comprises 5 to 60% by weight of the alkali metal silicate. Most preferably, the mixture comprises 6 to 55% by weight of alkali metal silicate.

In some examples, wherein the mixture comprises an oxide ceramic material and an aluminosilicate mineral (such as examples 1 & 2), the mixture comprises 1 to 15% by weight of clay. Preferably, the mixture comprises 4 to 13% by weight of clay. Most preferably, the mixture comprises 5 to 12% by weight of the clay.

In some examples, wherein the mixture comprises an oxide ceramic material and an aluminosilicate mineral (such as examples 1 & 2), the mixture comprises 20 to 70% by weight of alkali metal silicate. Preferably, the mixture comprises 25 to 60% by weight of the alkali metal silicate. Most preferably, the mixture comprises 30 to 55% by weight of alkali metal silicate.

In examples wherein the mixture comprises an oxide ceramic material and/or an aluminosilicate mineral, the alkali metal silicate may also contribute to the formation of the barrier to prevent or limit scale formation.

In examples wherein the mixture comprises glass frit (for example instead of an oxide ceramic material and an aluminosilicate mineral, such as example 3), alkali metal silicate (potassium silicate in the described example) is added primarily as a binder (with clay), and is not believed to significantly contribute to the formation of the barrier to prevent or limit scale formation. Accordingly, there is significantly less alkali metal silicate in examples wherein the mixture comprises glass frit instead of an oxide ceramic material and an aluminosilicate mineral (such as example 3).

In some examples, wherein the mixture comprises glass frit (for example instead of an oxide ceramic material and an aluminosilicate mineral, such as example 3), the mixture comprises 1 to 25% by weight of clay. Preferably, the mixture comprises 5 to 25% by weight of clay. Most preferably, the mixture comprises 10 to 20% by weight of the clay.

In some examples, wherein the mixture comprises glass frit (for example instead of an oxide ceramic material and an aluminosilicate mineral, such as example 3), the mixture comprises 1 to 20% by weight of alkali metal silicate. Preferably, the mixture comprises 3 to 20% by weight of the alkali metal silicate. Most preferably, the mixture comprises 5 to 15% by weight of alkali metal silicate.

### Rheology Modifier

In some examples, the mixture comprises a rheology modifier, for instance, a hydrocolloid preparation or a gum. Suitable hydrocolloid preparations include peptapon. Mixtures for application to metal substrates at low temperature, for example ambient temperature, comprise a rheology modifier to provide a required flow behaviour of a slurry formed from the mixture.

The gum may comprise xanthan gum. In examples comprising a rheology modifier, the mixture comprises 0.1% to 1.0% by weight of rheology modifier. Preferably, the mixture comprises 0.1 to 0.8% by weight of rheology modifier. Most preferably, the mixture comprises 0.2 to 0.5% by weight of rheology modifier.

Examples of the disclosure also provide a slurry for coating a metal substrate. The slurry comprises a mixture accordingly to examples of the disclosure suspended in water. In some example, the slurry comprises 15 to 65% by weight water, with the relative amounts of the components in the mixture (for example, as listed in the examples of table 1) proportionally adjusted accordingly. Preferably, the slurry comprises 20 to 55% by weight water.

In some examples, the slurry has a density relative to water of 1.2 to 2.2. Preferably, the slurry has a density relative to water of 1.5 to 2. For example, a slurry formed from the mixture of example 1, table 1 has a density relative to water of 1.9. In example 1 of table 1, the slurry comprises 30% by weight water, with the amount of the remaining components proportionally adjusted accordingly.

A slurry according to examples of the disclosure may be formed by mechanically dispersing the mixture into water, for example using a high shear mixer. In examples comprising glass frit, the glass frit may be wet or dry ball milled (to the required size). In some examples, the components of the mixture may be wet or dry ground together.

Examples of the disclosure also provide a barrier to prevent or limit scale formation on a metal substrate. The barrier is bound to the metal substrate. The barrier is the reaction product of a mixture according to examples of the disclosure.

In some examples, the coating applied to the metal substrate may begin to form a barrier to limit or prevent scale formation immediately following application of the mixture irrespective of the temperature of the metal substrate. In other examples, the coating applied to the metal substrate may begin to form a barrier to limit or prevent scale formation at an elevated temperature, for example, in excess of 500° C., or perhaps 800° C., or 900° C. depending on the composition of the mixture.

In examples of the disclosure, the crystallographic and amorphous phases of the coating may change during the heating process, forming a barrier to prevent or limit scale formation. There may also be a degree of fusion between components of the mixture.

Accordingly, as the metal substrate is heated, for example, up to a temperature of about 1200° C. (or in some instances about 1300° C.), the barrier is formed. The barrier may have a glassy structure. The barrier may be ceramic.

Examples of the disclosure also provide a method of preventing or limiting scale formation on a metal substrate. The method comprises coating the metal substrate with a mixture according to examples of the disclosure.

Scale would ordinarily form on a metal substrate as the metal substrate is heated. In some examples, the metal substrate is reheated during a forming process, i.e. the substrate has already been heated at least once before, for example, in formation of the metal substrate. Accordingly, examples of the disclosure also provide a method of preventing or limiting scale formation on a metal substrate during heating or reheating of the metal substrate.

In some examples, the metal substrate is heated or reheated up to a temperature of about 1200° C. or in some instances about 1300° C.

In some example, the mixture is applied as a layer with an average thickness of 100 μm to 400 μm. Preferably, the mixture is applied as a layer with an average thickness of 200 μm to 400 μm. Most preferably, the mixture is applied as a layer with an average thickness of 250 μm to 350 μm.

The method may comprise coating the metal substrate with the mixture in a manual or automated process. The mixture may be applied as a slurry, wherein the mixture comprises water as described above. The slurry may be applied by spraying the metal substrate. Alternatively, the mixture may be applied by electrostatic spraying. In such cases, mixtures according to examples of the disclosure may comprise about 0.5% by weight of silicone oil.

Advantageously, as the mixture comprises a binding system (clay and an alkali metal silicate) a metal substrate may be coated with the mixture when the temperature of the metal substrate is anywhere between ambient temperature and about 1300° C., and preferably when the temperature of the metal substrate is anywhere between ambient temperature and about 800° C. In examples where a slurry is applied to a metal substrate at ambient temperature, application may be by dipping, flooding or painting onto the surface of the metal substrate, and in some instance, subsequent air drying. In some examples, the dry mixture may be applied directly to the surface of the metal substrate, for instance, in examples where the metal substrate is at ambient temperature.

The mixture itself is applied at ambient temperature, i.e. the temperature of the mixture prior to application is ambient temperature.

In some examples, the method may comprise heating the metal substrate in air, i.e. at normal atmospheric levels of oxygen. In other example, a further reduction in scale formation may be achieved if the method is carried out in a low oxygen atmosphere, i.e. in which the atmosphere comprises less than 20% by volume oxygen.

There is thus described a mixture for coating a metal substrate to prevent or limit the formation of scale, a barrier, and a method of preventing or limiting scale formation on a metal substrate with a number of advantages as detailed above and as follows.

As noted above, during the process of reheating, significant levels of scale form on the surface of the metal substrate, for example steel substrate, due to oxidation of iron in the metal to iron oxides. In examples of the disclosure the barrier formed limits or prevents the formation of scale during heating or reheating of metal substrates. The barrier is a physical barrier which is at least impermeable to water and carbon dioxide.

As detailed in table 2 below, examples of the disclosure have been documented to reduce scale production on metal substrates, such as steel substrates, by 50%. For example, loss of steel through scale may be reduced from 3% (without applying a coating of the mixture to the surface of the metal substrate) to at least as low as 1.5 and in some examples to negligible amounts (when a coating of the mixture to the surface of the metal substrate has been applied and a barrier forms). In large scale operations, this represents a significant saving, and in particular with regard to the heating of metal substrates which have a large surface area.

The following trials were carried out on IF grade steel all with cut faces due to the size of billet required for lab scale trials (in practice the faces of the steel would be pre-oxidised). Billets were heated to 100° C. then sprayed with the mixture according to examples of the disclosure (see Table 1 above) and fired in an electric kiln in an atmosphere of 5% oxygen to 1240° C. for 40 mins. Once cooled to 800° C. the billets were quenched in cold water and loose scale removed. The billets were weighed before coating and after scale removal and % metal loss calculated, as indicated in table 2 below.

TABLE 2

| Mixture | Steel Type | % metal loss |
|---|---|---|
| None | IF | 3.98% |
| Example 3, table 1-coated 200 μm | IF | 2.56% |
| Example 1, table1-coated 300 μm | IF | 1.75% |
| Example 2, table1-coated 300 μm | IF | 2.10% |
| Example 3, table1-coated 300 μm | IF | 2.72% |
| Example 4, table1-coated 300 μm | IF | 2.15% |
| Example 5, table1-coated 300 μm | IF | 3.36% |
| Example 6, table1-coated 300 μm | IF | 3.65% |
| Example 7, table1-coated 300 μm | IF | 2.37% |
| Example 8, table1-coated 300 μm | IF | 1.65% |

Furthermore, any scale formed on the metal substrate, for instance prior to coating the metal substrate with a mixture according to examples of the disclosure, is readily removed with the barrier formed before and during subsequent forming processes (for example hot rolling), for instance, by high pressure water jets. The removed barrier, along with any scale, is compatible with existing recycling methods. Furthermore, the removed barrier and scale are compatible. Any scale formed has been found to be very thin and brittle. Any scale formed is bound to the barrier, and therefore does not bind well to the metal substrate, and is therefore easier to remove.

Examples of the disclosure are cost effective, and as noted mixtures according to examples can be applied to a metal substrate over a range of temperatures (from ambient to very high temperatures if required, i.e. up to about 1300° C.). Accordingly, mixtures can be applied to a metal substrate irrespective of whether the metal substrate is cold prior to heating, or already hot from a prior process. Accordingly, the metal substrate does not need to be cooled prior to applying the mixture, which reduces energy consumption and costs associated with the process.

Furthermore, examples of the disclosure are effective where the metal substrate is heated in a high humidity atmosphere, for example in a gas kiln.

The barrier formed according to examples of the disclosure is continuous, i.e. does not comprise cracks.

Although embodiments of the present invention have been described in the preceding paragraphs with reference to various examples, it should be appreciated that modifications to the examples given can be made without departing from the scope of the invention as claimed. For instance, the proportions of the respective components can be varied as required to a suit a particular application, for example, a slurry with a higher density may be formulated such that spraying for a set amount of time would deposit a greater amount of mixture onto a metal substrate. Examples of the disclosure prevent or reduce scale formation by providing a barrier in any application where scale may form on a metal substrate, for instance, hot forming extrusion, forging, or foundry applications. Accordingly, examples of the disclosure are not limited to applications where a metal substrate is reheated prior to a forming process, such as hot rolling. Significant amounts of scale does though form on metal substrates during reheating, and examples of the disclosure are particularly suitable for preventing or limiting scale formation in such reheating applications.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

The term “comprise” is used in this document with an inclusive not an exclusive meaning. That is any reference to X comprising Y indicates that X may comprise only one Y or may comprise more than one Y. If it is intended to use “comprise” with an exclusive meaning then it will be made clear in the context by referring to “comprising only one . . . ” or by using “consisting”.

In this brief description, reference has been made to various examples. The description of features or functions in relation to an example indicates that those features or functions are present in that example. The use of the term “example” or “for example” or “may” in the text denotes, whether explicitly stated or not, that such features or functions are present in at least the described example, whether described as an example or not, and that they can be, but are not necessarily, present in some of or all other examples. Thus “example”, “for example” or “may” refers to a particular instance in a class of examples. A property of the instance can be a property of only that instance or a property of the class or a property of a sub-class of the class that includes some but not all of the instances in the class. It is therefore implicitly disclosed that features described with reference to one example but not with reference to another example, can where possible be used in that other example but does not necessarily have to be used in that other example.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. A mixture for coating a metal substrate to prevent or limit scale formation, wherein the mixture comprises:
40 to 90% by weight glass frit; the mixture further comprising:
1 to 25% by weight of clay; and
1 to 20% by weight of an alkali metal silicate.

2. (canceled)

3. (canceled)

4. A mixture according to claim 1, wherein the alkali metal silicate comprises any of: sodium silicate, potassium silicate or lithium silicate.

5. A mixture according to claim 1, wherein the clay comprises china clay or ball clay.

6. A mixture according to claim 1, wherein the mixture 60 to 90% by weight glass frit.

7. A mixture according to claim 1, wherein the mixture comprises 65 to 85% by weight glass frit.

8. A mixture according to claim 1, wherein the mixture comprises 2 to 25% by weight of clay.

9. A mixture according to claim 1, wherein the mixture comprises 10 to 20% by weight of clay.

10. A mixture according to claim 1, wherein the mixture comprises 3 to 20% by weight of alkali metal silicate.

11. A mixture according to claim 1, wherein the mixture comprises 5 to 15% by weight of alkali metal silicate.

12. A mixture according to claim 1, wherein the mixture comprises a rheology modifier.

13. A mixture according to claim 1, wherein the glass frit comprises a plurality of different glass frits, wherein each respective glass frit has a different chemical composition.

14. A mixture according to claim 13, wherein each respective glass frit has a different softening point.

15. A mixture according to claim 13, wherein the glass frit comprises 2 to 5 different glass frits.

16. (canceled)

17. A slurry for coating a metal substrate to prevent or limit scale formation, wherein the slurry comprises a mixture according to claim 1 suspended in water.

18. A slurry according to claim 17, wherein the slurry has a density relative to water of 1.2 to 2.2.

19. A method of preventing or limiting scale formation on a metal substrate, wherein the method comprises:
coating the metal substrate with a mixture according to claim 1;
wherein the mixture comprises: 20 to 90% by weight of at least one of: an oxide ceramic material, an aluminosilicate mineral or glass frit; the mixture further comprising: 1 to 20% by weight of clay; and 3 to 70% by weight of an alkali metal silicate.

20. A method according to claim 19, wherein the method comprises coating the metal substrate with the mixture to provide a layer with an average thickness of 100 μm to 400 μm.

21. A method according to claim 19, wherein the method comprises coating the metal substrate with the mixture when the temperature of the metal substrate is anywhere between ambient temperature and about 1300° C.
